(19) United States
(12) Patent Application Publication
(10) Pub. No.: US 2006/0246275 A1
(43) Pub. Date: Nov. 2, 2006

(54) Fiber and sheet equipment wear surfaces of extended resistance and methods for their manufacture

(76) Inventors: Timothy Dumm, Westerville, OH (US); John William Lucek, Powell, OH (US); John Petreanu, Gahanna, OH (US); Marc Gary Davidson, Dublin, OH (US); Bruce Wayne Hofer, Lewis Center, OH (US)

Correspondence Address: Pepper Hamilton, 500 Grant Street, 50th Floor, Pittsburgh, PA, 15219, US

(21) Appl. No.: 10/544,797

(22) PCT Filed: Feb. 6, 2004
(86) PCT No.: PCT/US04/03473

§ 371 Date: May 31, 2006

Related U.S. Application Data
(60) Provisional application No. 60/445,614, filed on Feb. 7, 2003.

(51) Int. Cl. B05D 1/12; B32B 15/00; B32B 18/00; B32B 5/16

(52) U.S. Cl. 428/323; 427/180; 428/457; 428/702; 428/698; 428/332

(57) ABSTRACT

A method for producing process equipment having a wear surface having extended resistance to one or more of abrasion, erosion, or corrosion, associated with materials processed by said process equipment includes applying to said process. equipment wear surface a metal matrix coating filled with superabrasive particles. Diamond and cubic boron nitride superabrasive particles can fill the metal matrix, which can be a nickel coating.

### CROSS-REFERENCE TO RELATED APPLICATIONS

This application claims benefit of priority to provisional application 60/445,614, filed on Feb. 14, 2003.

### BACKGROUND OF THE INVENTION

The present invention relates to fiber and sheet process equipment that handle/process continuous fiber and sheet materials that may be filled with a second solid phase. The action of such fibers and sheets presents process wear surfaces with accelerated abrasion, corrosion, and/or erosion, to which the present invention provides improved resistance.

A variety of process equipment has wear surfaces that are subjected to accelerated abrasion, corrosion, and/or erosion including, for example, a web or thread of paper, fabric, plastic, glass, or the like fiber. Such fibers and sheets impinge upon the process equipment wear surface and cause accelerated abrasion, corrosion, and/or erosion.

While affixing or applying a wear-hardening layer to the process equipment wear surfaces, such as, for example, a liner, or manufacturing wear surfaces from more rugged material addresses the accelerated abrasion, corrosion, and/or erosion to some extent, the artisan is readily aware that much more is needed for a variety of applications for a wide variety of process equipment.

Heretofore, a variety of hard surface coatings have been proposed. U.S. Pat. No. 5,891,523 proposes a pre-heat treatment of a metal combing roll prior to an electroless Ni coating with diamond and U.S. Pat. No. 4,358,923 propose electroless coatings of metal alloy and particulates that include polycrystalline diamond. Molding dies have been hard faced with electroless coatings of Ni—P and NiP—SiC (Handbook of Hardcoatings. Bunshah, R. F. Editor, Noyes Publishing, 2001). It also has been proposed to co-deposit other solid particles within electroless Ni—P coatings, including SiC, B₄C, Al₂O₃, diamond, PTFE, MoS₂, and graphite (Apachitei, et al., “Electroless Ni—P Composite Coatings: The Effect of Heat Treatment on the Microhardness of Substrate and Coating”, Scripts Materials, Vol. 38, No. 9, pp. 1347-1353, Elsevier Sciences, Ltd. 1958). Additional Ni—P wear coatings are discussed by Bozzini, et al., “Relationships among crystallographic structure, mechanical properties and tribiological behavior of electroless Ni—P (9%)/B₄C films”, Wear, 225-229 (1999) 806-813; Wang, et al., “Scuffing and wear behavior of aluminum piston skirt coatings against aluminum cylinder bore”, Wear, 225-229 (1999) 1100-1108; Hamid, et al., “Development of electroless nickel-phosphorous composite deposits for wear resistance of 6061 aluminum alloy”, Material Letters, 57 (2002) 720-726; Palumbo, et al., “Electrodeposited Nanocrystalline Coatings for Hard-Facing Applications”, AESF SUR/FIN® Proceedings, 686, 2002 Proceedings; Mallory, et al., “Composite Electroless Plating”, Chapter 11, Electroless Plating: Fundamentals and Applications, American Electroplaters and Surface Finishers Society (1990); and Feldstein, et al., “Composite Electroless Nickel Coatings for the Gear Industry”, Gear Technology, The Journal of Gear Manufacturing, 1997. A general statement on the principal of electroless nickel plating is given in Wear in Plastics and Processing, Chapter 2. Metals and Wear Resistant Hardfacings; 171 (1990).

### BRIEF SUMMARY OF THE INVENTION

One aspect of the invention is a method for producing process equipment, which has a wear surface having extended resistance to one or more of abrasion, erosion, or corrosion associated with filled materials processed by the process equipment. Such extended resistance is achieved by forming the process equipment wear surface to bear a metal matrix composite filled with abrasive particles. Another aspect of the present invention is process equipment having a wear surface having extended resistance to one or more of abrasion, erosion, or corrosion associated with filled materials processed by said process equipment, wherein the equipment wear surface bears a metal matrix composite filled with abrasive particles.

A variety of process equipment will be described below, which equipment wear surfaces exhibit extended resistance to abrasion, erosion, or corrosion associated with filled materials processed by the process equipment. The invention will be exemplified by plating wear surface parts with a superabrasive composite. It should be understood, however, that additional processes for associating the filled composite can be practiced, as the skilled artisan is readily aware.

### BRIEF DESCRIPTION OF THE DRAWINGS

For a fuller understanding of the nature and advantages of the present invention, reference should be had to the following detailed description taken in connection with the accompanying drawings, in which:

FIG. 1 is a plan view of a conventional glass fiber collection comb;

FIG. 2 is one embodiment of a conventional rotary traversing system for facilitating drying and high speed unwinding of glass strands; and

FIG. 3 graphically displays the results recorded in the Example for sliding wear data of various steels on a comparative Ni—P coating and the inventive metal matrix composite coating.

The drawings will be described in further detail below.

### DETAILED DESCRIPTION OF THE INVENTION

For the sake of clarity of understanding, the following terms are defined below (the singular includes the plural and vice versa):
“filler” means a solid or solid-like particle (often finely-divided, such as, for example, particulates, flakes, whiskers, fibers, and the like) that, when in a relative movement situation with a wear surface, also can cause accelerated abrasion, corrosion, and/or erosion and which comprises one or more of a ceramic, glass, mineral, cermet, metal, organic material (e.g., a plastic), cementitious material, cellulosic, or biomass (i.e., materials or secretions from a once-living organism, including, inter alia, bacteria, mollusk shells, virus particles, cell walls, nut shells, bones, bagasse, ice crystals, and the like). Fillers also may be wanted (added, formed in situ, or the like) or may be unwanted (by-product, contaminant, or the like).
“filled” means that the continuous fiber or sheet retains a filler in a different phase from the continuous fiber or sheet, including, inter alia, particulates, flakes, whiskers, fibers, and the like.
“flowable” means that the continuous fiber or sheet moves spatially relative to the process equipment wear surface, whether by movement of the wear surface, movement of the material, or movement of both; and includes relative movement by the movement of the continuous fiber or sheet, movement by gravity, movement by positive/negative pressure, and the like; whether such movement is intended or not.
“process equipment” means equipment that handles continuous fibers and sheets (filled and unfilled), whether by simple movement or by performing a chemical/mechanical/electrical operation on the material, and includes components of the process equipment that may have an intended or unintended wear surface.
“superabrasive particle” means monocrystalline diamond (both natural and synthetic) and cBN.
“metal matrix composite” means a metal that bears a superabrasive particle.
“wear surface” means a surface of the process equipment (or a component thereof that has an intended or unintended wear surface) that is subject to abrasion, corrosion, and/or erosion by the action of the continuous fiber or sheet.

A wide variety of process equipment handles continuous fiber and sheet and has one or more wear surfaces that are subject to abrasion, corrosion, and/or erosion by moving action impinging on a wear surface. Such wear surfaces can be coated with a metal matrix composite and exhibit extended resistance to the deleterious action of the filler contacting such wear surfaces during movement of the filler.

Superabrasive Particles

Superabrasive or superhard materials in general refer to diamond, cubic boron nitride (cBN), and other materials having a Vickers hardness of greater than about 3200 kg/mm² and often are encountered as powders that range in size from about 1000 microns (equivalent to about 20 mesh) to less than about 0.1 micron. Industrial diamond can be obtained from natural sources or manufactured using a number of technologies including, for example, high pressure/high temperature (HP/HT), chemical vapor deposition (CVD), or shock detonation methods. CBN only is available as a manufactured material and usually is made using HP/HT methods.

Superabrasive (sometimes referred to as “ultra-hard abrasive” materials) are highly inert and wear resistant. These superabrasive materials offer significantly improved combined wear (abrasion and erosion) and corrosion resistance when used as wear surface of forming tools.

In one embodiment, optional abrasive materials may be added to the superabrasive materials. Those abrasive materials can be fine solid particles being one or more of the boron-carbon-nitrogen-silicon family of alloys or compounds, such as, for example, hBN (hexagonal boron nitride), SiC, Si₃N₄, WC, TiC, CrC, B₄C, Al₂O₃. The average size of the abrasive materials (superabrasives as well as optional materials, sometimes referred to as “grit”) selected is determined by a variety of factors, including, for example, the type of superabrasive/abrasive used, the type of the process equipment, the type of filled materials handled, and like factors.

In one embodiment of the invention, the volume percent of the superabrasive or abrasive particles that comprises the composite coating can range from about 5 volume percent (vol-%) to about 80 vol-%. The remaining volume of the coating in the composite consists of a metallic matrix that binds or holds the particles in place plus any additives.

In another embodiment of the invention, the particle size ranges for the abrasive materials in the composite are about 0.1 to up to about 6 mm in size (average particle size). In a further embodiment, the particle size ranges from about 0.1 to about 50 microns. In a yet further embodiment, the particle size ranges from about 0.5 to about 10 microns.

Depositing Coating(s) of Metal/Diamond (or cBN)

In one embodiment of the invention, a process for conventional electroplating of abrasives is used to deposit at least a coating of the superabrasive composites comprising diamond and/or cBN onto the wear surface(s) of the process equipment. The superabrasive composites are affixed to the wear surface(s) by at least one metal coating using metal electrodeposition techniques known in the art.

In one embodiment of the electroplating process, metal is deposited onto the process equipment wear surface until a desired thickness is achieved. The metal coating(s) have a combined thickness ranging from about 0.5 to about 1000 microns, and in one embodiment about 10% to about 30% of the height (i.e., diameter or thickness) of one abrasive particle in the superabrasive composites.

The metal material for the electrode or the opposite electrode to be composite electroplated is selected from shaped materials of one or more of nickel, nickel alloys, silver, silver alloys, tungsten, tungsten alloys, iron, iron alloys, aluminum, aluminum alloys, titanium, titanium alloys, copper, copper alloys, chromium, chromium alloys, tin, tin alloys, cobalt, cobalt alloys, zinc, zinc alloys, or any of the transition metals and their alloys. In one embodiment, the metal ions contained in the composite electroplating liquid are ions of one or more of nickel, chromium, cobalt, copper, iron, zinc, tin, or tungsten. The metal ions form a metal matrix of a single metal or an alloy or an, for example, oxide, phosphide, boride, silicide, or other combined form of the metal. When Ni is the metal matrix of choice, for example, Ni can be in the form of nickel-phosphorus (Ni—P) having a P content of less than about 5% by weight in one embodiment and less than about 3 wt-% in another embodiment.

The superabrasive particles of the present invention, i.e., diamond or cubic boron nitride, and optional abrasive materials, are introduced into the plating bath for deposition onto the plated metal. The amount of superabrasive particles in the plating bath mixture can range from about 5% to about 30% by volume.

In another embodiment of the invention, an electroless metal plating process is used to place the superabrasive coating onto the process equipment wear surface. This process is slower than that of the electroplating process; however, it allows for the plating of the superabrasive coating of the present invention onto process equipment wear surface with intricate surfaces, e.g., deep holes and vias. Electroless (autocatalytic) coating processes are generally known in the art, and are as disclosed, inter alia, in U.S. Pat. No. 5,145,517, the disclosure of which is expressly incorporated herein by reference.

In one embodiment of an electroless metal process, the process equipment wear surface is in contact with or submerged in a stable electroless metallizing bath comprising a metal salt, an electroless reducing agent, a complexing agent, an electroless plating stabilizer of a non-ionic compound along with one or more of an anionic, cationic, or amphoteric compound, and quantity of the superabrasive particulates, which are essentially insoluble or sparingly soluble in the metallizing bath, and optionally a particulate matter stabilizer (PMS).

The superabrasives or grit are maintained in suspension in the metallizing bath during the metallizing of the process equipment wear surface for a time sufficient to produce a metallic coating of the desired thickness with the superabrasive materials dispersed therein.

In one example of a metallizing bath, in addition to the diamond or cBN, a wide variety of distinct matter can be added to the bath, such as, for example, ceramics, glass, talcum, plastics, graphites, oxides, silicides, carbonates, carbides, sulfides, phosphates, borides, silicates, oxylates, nitrides, fluorides of various metals, as well as metal or alloys of, for example, one or more of boron, tantalum, stainless steel, chromium, molybdenum, vanadium, zirconium, titanium, and tungsten. Along with the superabrasive materials, the particulate matter is suspended within the electroless plating bath during the deposition process and the particles are co-d posited within the metallic or alloy matrix onto the surface of the forming tools.

In one embodiment of the invention, prior to the plating process, the process equipment wear surface to be metallized/coated is subjected to a general pretreated (e.g., cleaning, strike, etc.) prior to the actual deposition step. In another embodiment, in addition to the actual plating (deposition), there is an additional heat treatment step after the metallization of the wear surface (substrate) of the forming tool. Such heat treatment below about 400° C. provides several advantages, including, for example, improved adhesion of the metal coating to the substrate, a better cohesion of matrix and particles, as well as the precipitation hardening of the matrix.

In yet another embodiment of the invention and depending on the end-use of the process equipment, after the completion of the electroless or electroplating process to coat the superabrasive materials onto the surface of the forming tools, an organic size coating may be applied over the metal coating(s) and the superabrasive composites. Examples of organic size coatings include one or more of phenolic resins, epoxy resins, aminoplast resins, urethane resins, acrylate resins isocyanurate resins, acrylated isocyanurate resins, urea-formaldehyde resins, acrylated epoxy resins, acrylated urethane resins or combinations thereof; and may be dried, thermally cured or cured by exposure to radiation, for example, ultraviolet light.

Continuous Fiber Handling

Glass fiber, for example, is produced at, for example, about 2-5 km per minute. Gathering individual fibers into strand, applying sizing, and winding at this speed causes considerable wear on fixed fiber and strand positioning systems that, if not corrected, degrade the fiber. Graphite, phenolic composite, polished metal, and ceramic components are refurbished or replaced as often as several times each day, consuming labor, production time, and wasting e fiber. Guides and other components in subsequent chopping, roving, and yarn production steps also wear in use. The total cost of this wear approaches $1 million for a large continuous fiber plant.

Continuous glass strands are generated by drawing molten glass from multiple bushings, attenuating the glass stream to draw it into fine fibers, quenching the fiber to an amorphous solid, applying protective sizing, gathering individual fibers into a multifilament strand, and finally, with a traversing system, laying the strand uniformly across a rotating spool for subsequent drying and processing. The driven spool provides the force necessary to draw the fiber and overcome friction in the sizing and guiding systems. Wear and contamination in the sizing and guiding systems can damage the sizing used to protect the surface of the fiber, potentially degrading fiber strength and in the extreme case interrupting production. To prevent this, guiding components are continually cleaned, polished, and replaced before damage can occur. This controlled replacement interrupts production at least once per 8-hour shift, reducing production and, of itself, generating scrap material.

Non-limiting examples of this wear include the following:

Sizing Applications: Once the fiber has been quenched to an amorphous solid, sizing is applied by pulling individual fibers across a fixed surface, roller, or continuous belt saturated with the sizing compound. Broken fibers and dried sizing cause wear of the applicator. Wear grooves on the applicator contribute to non-uniform application of the sizing.

Collection Combs: Once the sizing is transferred to protect individual fibers, they a collected into a multi-filament strand by roller guides or, most commonly, by stationary combs. Combs are made of phenolic composites or graphite and wear rapidly in service. A typical geometry is illustrated in FIG. 1. Fibers are gathered in the circular holes, 10-20, between the “teeth”, 22-34, of the comb, 36. Holes 10-20 wear in service and combs, i.e., comb 36, must be reworked to a regular, smooth geometry.

The combs must be chemically inert to the glass and sizing, easily cleaned or not wetted by the sizing solution, strong enough to resist handling, sufficiently high thermal conductivity to dissipate frictional heating, electrically conductive to dissipate static charges, and easily re-machined. A low coefficient of sliding friction is needed to minimize system forces acting on the strand. Neither graphite nor phenolic composites present optimum solutions.

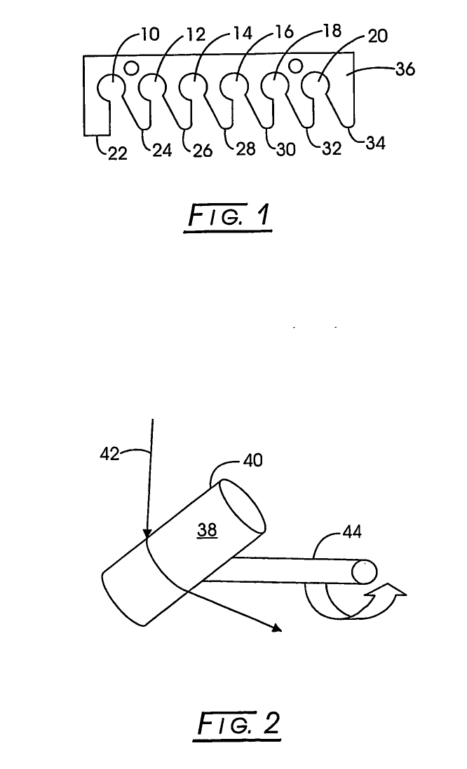

Fiber Winding: Glass strands must be uniformly laid onto spools to facilitate drying and high speed unwinding for subsequent operations. Traversing guides place the strands at a slight angle on the spool body. Two rotary traversing systems are commonly used. In the first, a soft brass wire is used to form two opposite, helical guides around a central shaft. Shaft rotation drives the strand laterally back and forth across the rotating spool. The brass alloy wires must be maintained in a highly polished state to prevent fib r damage. The second design is illustrated in FIG. 2 and comprises a cylindrical wear surface, 38, of a spool, 40, on which the strand, 42, rides mounted on a rotating shaft, 44. The rotation causes strand 42 to translate laterally with respect to the shaft axis of spool 40. Surface 38 commonly is coated with a fine-grained ceramic to resist wear. This coating must possess the same characteristics as the brass wire assembly.

Neither of these spool designs provides long service life and spools are replaced regularly along with the combs.

In this embodiment of the present invention, then, the wear surfaces of, inter alia, glass fiber processing equipment are coated with the metal matrix composite filled with abrasive particles. The same process as described above (e.g., electrolytic or electroless) is used in the same manner as described in greater detail for the forming equipment.

Other synthetic fibers and inorganic fibers can be processed or handled with similar equipment to the continuous glass fiber equipment discussed above and are within the precepts of the present invention.

Additionally, sheets made from such inorganic and synthetic fibers are handled by equipment that also has wear surfaces subject to abrasion, corrosion, and/or erosion caused by the relative movement of the sheet and a wear surface. Such wear surfaces may be components of the process equipment that are unintended wear surfaces and often are components that are merely conveying the web or sheet from one location to another location.

While the invention has been described with reference to preferred embodiments, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. The following example shows how the present invention has been practiced, but should not be construed as limiting. In this application all units are in the metric system and all amounts and percentages are by weight, unless otherwise expressly indicated. Also, all citations referred herein are expressly incorporated herein by reference.

### EXAMPLE

A Sliding Wear Test is the study of friction and wear behavior of two interacting, solid surfaces in relative motion. Different material pairs, under different contact conditions, can be studied using this test. The instrument used is high temperature tribometer from CSM Instruments SA. The temperature capability for the instrument is 800° C., and has a pin-on-disc configuration. This test was chosen to demonstrate the advantageous wear protection offered by the inventive process equipment wear surfaces to solids that move across such wear surfaces, such as, for example, continuous synthetic and inorganic fiber, and sheets.

The instrument has a sample holder, where a 55 mm diameter disc (coated or uncoated), with a height of 5-10 mm, can be mounted and screwed to the instrument. The other contact material (i.e., counterpart, such as, for example, a continuous fiber) can be a pin (cylinder, 6 mm diameter, 10 mm height) or a ball (6 mm diameter). The disc can be rotated at a speed of 0-500 rpm, while the pin is stationary. The pin holder holds the pin tightly at the bottom, against the disc. The pin is loaded with a load of 1-10N. The radius of the track on the disc can be anywhere between 10-20 mm. A trace of friction coefficient against time and sliding distance, for a certain material combination, can be obtained through the computer interface. The wear loss of disc and pin is obtained by measuring the weight, before and after the test. The samples are ultrasonically cleaned in acetone before the weight measurements are done.

The following coating procedure was used to coat the disc:

1. Pretreatment Steps for Activating Metal Surface for Nickel Plating:

(a) As generally described in Metals Handbook, Ninth Edition, “Selection of Cleaning Process”, pp. 3-32, American Society for Metals, 1982.
   2. Plating Process:
(b) As generally described in Metals Handbook, Ninth Edition, “Electroless Nickel”, pp. 219-223, American Society for Metals, 1982; or Sheela, et. al., “Diamond-Dispersed Electroless Nickel Coatings,” Metal Finishing, 2002. The nickel bath generally comprised:
   (i) 6 volume percent nickel sulfate solution containing 26 g/L nickel.
   (ii) 15 volume percent sodium hypophosphate solution containing 24 g/L hypophosphate.
   (iii) 74 volume percent de-ionized water.
   (NOTE: The Ni concentration of the bath is maintained at about 5.4-6.3 g/L throughout the operation.)
(c) Heat nickel bath to approximately 190° F. (87°-88° C.).
(d) 5 grams per liter of 1-3 micron monocrystalline diamond powder and pre-disperse in 5 volume percent de-ionized water (5 volume percent of nickel bath).
(e) Attach disc to rotating racking system and submerge in solution.
(f) Begin rotating parts slowly (approx. 0.5-2 rpm) and add diamond slurry.
(g) Every fifteen minutes, replenish the bath as follows:
   (i) 0.6 volume percent nickel sulfate
   (ii) 0.6 volume percent pH modifier
(h) Run plating process long enough for 30 minutes until desired thickness of 10 microns is obtained. (This process generally shows a plating rate of about 20 to 25 microns per hour).
(i) When approaching desired stopping point, allow the bath to “plate out” by eliminating the last replenishment.
(j) Remove plated part from solution and rinse with water. Wipe dry to eliminate watermarks.
(l) Remove stop-off used for masking the mold.
   4. Heat Treating:

Place coated part into furnace and heat to 300 to 350° C. for 1 to 2 hours in air atmosphere.

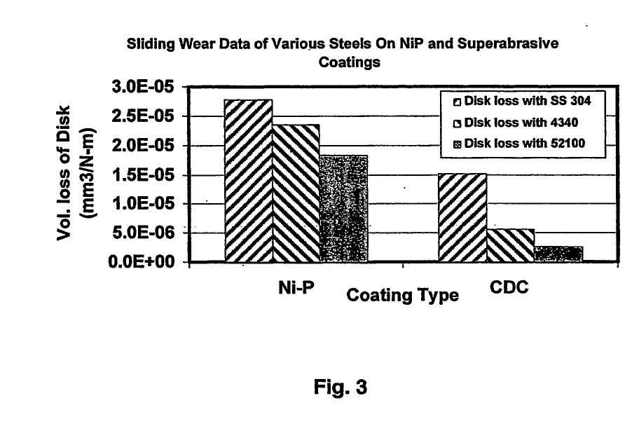

The coatings were tested at room temperature, under dry conditions against standard reference materials (pins) made from stainless steel 304, high strength low alloy steel 4340, and bearing steel 52100. The two important outputs from pin-on-disc test are: coefficient of friction and wear loss. A load of 10 N and 0.5 m/s sliding velocity was considered the optimum test condition, and has been used for all the tests in this study. Each test represents 2000 meters of sliding wear or approximately 66 minutes of wear time. The wear loss data for these tests are displayed in Table 1 and in FIG. 3.

TABLE 1

Disk Surface Material

| Pin Material | Ni—P | Inventive Ni—P |
|---|---|---|
| Stainless Steel 304 | 2.77 × 10⁻⁵ | 1.51 × 10⁻⁵ |
| HSLA 4340 | 2.35 × 10⁻⁵ | 0.566 × 10⁻⁵ |
| Bearing Steel 52100 | 1.83 × 10⁻⁵ | 0.254 × 10⁻⁵ |

These data show that the inventive wear surfaces with monocrystalline diamond in the Ni—P metal coating displayed much better wear characteristics than 5 the Ni—P metal coating without monocrystalline diamond. For Stainless Steel 304, the inventive wear surface exhibited a reduction in friction of over 45%. For both HSLA 4340 and Bearing Steel 52100, the inventive wear surface exhibited a reduction in friction of over an order or magnitude. This is especially evident in FIG. 3 which graphically displays the data reported in Table 1.

1-42. (canceled)

43. Process equipment, comprising:
a continuous fiber wear surface having a composite coating, wherein the composite coating comprises a metal and superabrasive particles.

44. The process equipment of claim 43, wherein the continuous fiber wear surface comprises a surface that, when used, is subject to abrasion, corrosion or erosion by the processing of a continuous fiber or sheet.

45. The process equipment of claim 43, wherein:
the composite coating comprises between about 5 and about 80 volume-percent superabrasive particles;
the average particle size of the superabrasive particles ranges from about 0.1 to about 50 microns;
the metal comprises nickel, nickel alloys, silver, a silver alloy, tungsten, a tungsten alloy, iron, an iron alloy, aluminum, an aluminum alloy, titanium, a titanium alloy, copper, a copper alloy, chromium, a chromium alloy, tin, a tin alloy, cobalt, a cobalt alloy, zinc, a zinc alloy, a transition metal, or a transition metal alloy; and
the coating has a thickness from about 0.5 to about 1000 microns.

46. The process equipment of claim 43, wherein the coating further comprises nickel, a nickel alloy, silver, a silver alloy, tungsten, a tungsten alloy, boron, tantalum, stainless steel, chromium, molybdenum, vanadium, zirconium, titanium, tungsten, a ceramic, a glass, talcum, a plastic, a metal graphite, a metal oxide, a metal silicide, a metal carbonate, a metal carbide, a metal sulfide, a metal phosphate, a metal boride, a metal silicate, a metal oxylate, a metal nitride, or a metal fluoride.

47. The process equipment of claim 46, wherein the coating further comprises hexagonal boron nitride (hBN), SiC, Si₃N4, WC, TiC, CrC, B₄C, or Al₂O₃.

48. The process equipment of claim 43, wherein the coating is overcoated with an organic coating comprising a phenolic resin, epoxy resin, aminoplast resin, urethane resin, acrylate resin, isocyanurate resin, acrylated isocyanurate resin, urea-formaldehyde resin, acrylated epoxy resin, or acrylated urethane resin.

49. The process equipment of claim 43, wherein the wear surface is that of a fiber sizing surface.

50. The process equipment of claim 43, wherein the wear surface is a that of a collection comb.

51. The process equipment of claim 43, wherein the wear surface is that of a fiber winding spool.

52. A method of producing process equipment, comprising:
applying to a continuous fiber wear surface a composite coating that comprises a metal and superabrasive particles.

53. The method of claim 52, wherein the wear surface is that of a fiber sizing surface.

54. The method of claim 52, wherein the wear surface is that of a collection comb.

55. The method of claim 52, wherein the wear surface is that of a fiber winding spool.

56. The method of claim 52, wherein the applying comprises:
depositing, via an electroplating process, metal onto the wear surface until a desired thickness is achieved; and
introducing superabrasive particles into a plating bath of the electroplating process, wherein the superabrasive particles comprise about 5% to about 30% by volume of the plating bath.

57. The method of claim 56, further comprising applying an organic size coating over the composite coating.

58. The method of claim 52, wherein the applying comprises:
submerging the wear surface in a stable electroless bath comprising a metal salt, al electroless reducing agent, a complexing agent, an electroless plating stabilizer, and superabrasive particulates; and
maintaining the superabrasive particulates in suspension in the bath for a time sufficient to produce the composite coating at a desired thickness on the wear surface.

59. The method of claim 58, further comprising applying an organic coating over the composite coating, wherein the organic coating comprises a phenolic resin, epoxy resin, aminoplast resin, urethane resin, acrylate resin, isocyanurate resin, acrylated isocyanurate resin, urea-formaldehyde resin, acrylated epoxy resin, or acrylated urethane resin.

60. The method claim 58, wherein the bath further comprises ceramics, glass, talcum, plastic, graphite, oxides, silicides, carbonates, carbides, sulfides, phosphates, borides, silicates, oxylates, nitrides, fluorides, metal or an alloy.
